(19) United States
(12) Patent Application Publication
(10) Pub. No.: US 2026/0340180 A1
(43) Pub. Date: Oct. 29, 2026

(54) PRIVACY PRESERVING DATA PROTECTION INCLUDING HOMOMORPHIC KERNEL FUSION

(71) Applicant: Microsoft Technology Licensing, LLC, Redmond, WA (US)

(72) Inventor: Aditya Vasanth CHALLAPALLY, San Francisco, CA (US)

(21) Appl. No.: 19/193,202

(22) Filed: Apr. 29, 2025

(51) Int. Cl. G06F 21/62; G06F 21/60; H04L 9/00

(52) U.S. Cl. CPC G06F 21/6245; G06F 21/602; H04L 9/008

(57) ABSTRACT

Techniques and systems are disclosed to optimize aspects of data protection, including with the use of homomorphic encryption and other privacy-protecting measures. Optimizing data protection of a data stream may include: segmenting the data stream into data portions; assigning sensitivity scores to the data portions based on a sensitivity of contents provided therein; selecting security levels for data protection of the data portions (e.g., encryption) based on a respective sensitivity score assigned to a respective data portion, as the security levels correspond to varying strengths of the data protection; determining the security levels to apply to the data portions, as the data portions are processed with combined data processing operations on the data portions associated with a same security level; and applying the data protection to the data portions by applying the varying strengths of the data protection to the data portions in accordance with the determined security levels.

### BACKGROUND

As electronic devices capture and collect more data, these devices are increasingly used to process and analyze data in real time—while also satisfying privacy concerns that arise from handling sensitive information such as users' biometrics or personal data. Many devices have introduced security measures to handle such data, including the use of on-device data protections such as encryption of data in rest (e.g., when hosted in memory) and in transit (e.g., when communicated over a network). However, obtaining a balance between robust data protection and computational efficiency can present significant challenges, particularly in scenarios where battery life and processing power are limited.

In particular, there can be significant computational overhead needed when applying comprehensive encryption methods such as homomorphic encryption on individual devices. The increased use of these and other advanced encryption techniques has meant that client devices are often required to handle complex mathematical operations to process and encrypt data without compromising real-time performance or energy efficiency. As data capture and the corresponding demand for local, secure processing continues to grow, there exists an important need to offer efficient privacy protection without overwhelming the limited resources in device hardware.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of an architecture for a data protection system enabling privacy-preserving data processing, according to various examples.

FIG. 2 illustrates a schematic data flow in a data protection system enabling privacy-preserving data processing, according to various examples.

FIG. 3 illustrates a schematic data flow of optimizing neural network kernel fusion patterns based on data privacy analysis, according to various examples.

FIG. 4 illustrates a schematic block diagram of an architecture for distributed data processing and security functions, according to various examples.

FIG. 5 illustrates a flowchart of a use case for processing video data including operations in multiple security domains, according to various examples.

FIG. 6 illustrates a schematic of operational and functional components used among data source, data processing, and data output devices, according to various examples.

FIG. 7 depicts a flowchart of a method for optimizing data protection using sensitivity-based security levels and kernel fusion, according to various examples.

FIG. 8 is a block diagram illustrating an example of a machine upon which one or more embodiments may be implemented.

### DETAILED DESCRIPTION

Disclosed in some examples are methods, systems, devices, and associated operations and functionality that support the use of data protection in connection with data processing operations. In particular, techniques are described to determine data privacy requirements of incoming data, and in response, selecting and optimizing the security levels applicable to the incoming data, and applying some data protection operation (e.g., encryption, transformation, masking, obfuscation, tokenization, etc.) to the data. Based on this optimization, the overall workflow of various types of data processing operations can be improved, including but not limited to data processing performed with different kernel fusion patterns used in the computations of a neural network.

Specific example architectures are disclosed that support data flows involving specialized levels of homomorphic encryption and kernel fusion. One such architecture adapts progressive cascading neural network kernels, including fused (e.g., merged or combined) kernels to accomplish privacy-protected machine learning operations (e.g., training and inference) on homomorphic encrypted data. Additionally, scheduling of the neural network kernels can be arranged to enable efficient, secure computation of the machine learning operations on devices, while maintaining data privacy and underlying data protections. This architecture integrates sensitivity-based encryption levels, privacy-aware optimization techniques, and efficient processing protocols, which provide many benefits for resource-constrained environments.

One of the technical problems addressed by the present approaches includes inefficiencies related to the application of data protections such as encryption. Existing implementations that apply encryption often suffer from significant performance overhead and do not effectively address varying privacy requirements across different data types and operations, especially in neural network and other machine learning computation. For instance, some existing approaches choose to apply uniform strong encryption levels to all data, resulting in unnecessary computational burden and inefficient resource utilization. The inefficient handling of varying data sensitivity levels can be complicated when encountering resource constraints on edge devices.

One of the technical solutions introduced with the present architecture is improved efficiency of data processing operations, enabled by providing data protections customized to different security levels. For example, when used with homomorphic encryption data protection, the following approaches can apply multi-level (e.g., full, partial, or none) homomorphic encryption based on corresponding levels of data sensitivity. The data processing operations on the protected data can be coordinated with privacy-aware kernel fusion operations, such as with neural network kernels that are combined and scheduled to handle data of the same security level. This results in a reduced overhead for applying data protection techniques such as encryption, efficient computation to process data of the same security level, and accompanying savings in processing power, storage and memory resources, bandwidth, etc. These and other technical benefits will be apparent from the following examples and illustrations.

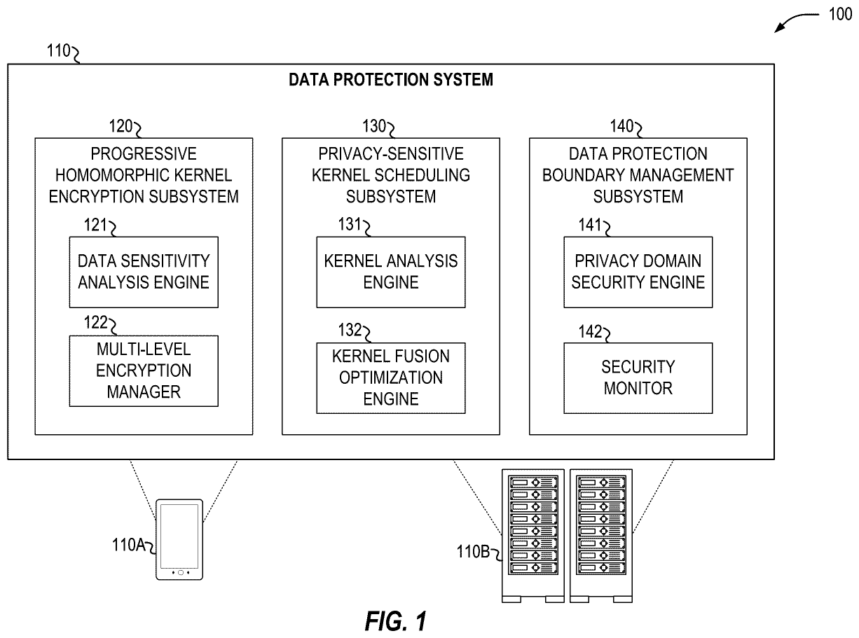

FIG. 1 illustrates an example architecture 100 of a data protection system 110 for implementing the operations discussed herein. The data protection system 110 is shown as being implemented by a mobile computing device 110A (e.g., a smartphone) or a server computing system 110B (e.g., a data center) or both. In other examples, the data protection system 110 may be implemented in part or in whole at network edge devices such as wearables, Internet-of-Things devices, gateways, and other devices with limited processing resources. For example, in a distributed system, portions of the data sensitivity analysis and encryption operations may be performed by low-processing power devices, whereas the neural network kernel computation operations may be performed by another system.

The data protection system 110 includes a progressive homomorphic kernel encryption subsystem 120, a privacy-sensitive kernel scheduling subsystem 130, and a data protection boundary management subsystem 140. These subsystems work together to coordinate data protection (encryption), computation (kernel optimization), and security operations for data with different levels of sensitivity. Although homomorphic encryption and the use of neural network computation is illustrated in this example, the data protection system 110 may be adapted for other types of data protection besides homomorphic encryption and other types of computation besides neural network inferencing and training.

The progressive homomorphic kernel encryption subsystem 120 is configured to implement multi-level encryption based on sensitivity, manage sensitivity-based encryption including encryption level transitions of data options, and maintain privacy guarantees. In particular, the progressive homomorphic kernel encryption subsystem 120 maintains privacy guarantees through an evaluation of a data function such as: E(d)=f(data_sensitivity, context_risk) where f determines an appropriate encryption level.

The progressive homomorphic kernel encryption subsystem 120 includes a data sensitivity analysis engine 121 to analyze the sensitivity of incoming data and assess a suitable sensitivity level, rating, or score for the data. In one example, the data sensitivity analysis engine 121 uses a machine learning model (e.g., a neural network) to classify data streams based on content type, regulatory requirements, and privacy implications of the incoming data. The data sensitivity analysis engine 121 also analyzes data patterns to detect personally identifiable information (PII), financial data, health records, etc. The data sensitivity analysis engine 121 also can maintain a dynamic sensitivity map that tracks data transformations performed on the data at various locations in a network.

In an example, the data sensitivity analysis engine 121 applies a continuous scoring system (0-1) for data sensitivity. For instance, the data sensitivity analysis engine 121 may implement a sensitivity analysis function for assigning a score S(x), such as with the following function: S(x)=α₁C(x)+α₂R(x)+α₃I(x) where: C(x) is an assessment of data criticality, R(x) is an assessment of regulatory requirements, and α values are weighting factors.

The progressive homomorphic kernel encryption subsystem 120 also includes a multi-level encryption manager 122 to apply a particular level of data protection, such as encryption data protection, based on the relevant security level and computation considerations. In an example, the multi-level encryption manager 122 performs an encryption level selection that maintains discrete encryption levels and implements encryption level transition protocols. For example, the multi-level encryption manager 122 may implement an optimization function L=L_privacy +λ₁L_performance +λ₂L_resource where: L_privacy ensures privacy guarantees, L_performance measures computational efficiency, and L_resource measures resource utilization.

In an example, the multi-level encryption manager 122 selects one of a plurality of security levels that corresponds to varying strengths of data protection, such as varying strengths of encryption. For example, four distinct encryption levels can be established for use with homomorphic encryption as follows:
Level 1: Full homomorphic encryption for highest sensitivity data
Level 2: Somewhat homomorphic encryption for moderate sensitivity
Level 3: Partial homomorphic encryption for low sensitivity
Level 4: Lightweight encryption for public/non-sensitive data

Each level may use specific encryption schemes such as the following:
Level 1: TFHE (Torus Fully Homomorphic Encryption)
Level 2: BGV fully homomorphic encryption applied with reduced parameters
Level 3: Paillier encryption for additive operations
Level 4: Lightweight authenticated encryption

Other variations to these encryption schemes may be used.

The privacy-sensitive kernel scheduling subsystem 130 is configured to analyze data flow for privacy requirements, optimize kernel fusion patterns, and maintain performance constraints. The privacy-sensitive kernel scheduling subsystem 130 includes a kernel analysis engine 131 that performs static analysis of neural network kernels, maps data dependencies between operations, identifies privacy boundaries where data sensitivity changes, and creates a computational graph with privacy annotations. Once the neural network kernels are fused and optimized, subsequent data protection operations that use the neural network can be optimized (e.g., by changing security levels of which encryption to apply) to take advantage of the optimized fused neural network kernels.

In an example, the kernel analysis engine 131 optimizes kernel fusion patterns through a function P(k)=min(computation_cost) subject to the following constraints: privacy_level≥required_privacy, latency≤max_delay, and accuracy≥min_accuracy.

The privacy-sensitive kernel scheduling subsystem 130 also includes a kernel fusion optimization engine 132 that implements intelligent kernel fusion based on privacy requirements. The kernel fusion optimization engine 132 uses dynamic programming to find optimal kernel fusion patterns, considers privacy constraints during optimization, and implements a cost model. For example, the cost model may be configured to balance properties such as: computational efficiency; memory usage; privacy requirements; and power consumption. Based on this analysis, the kernel fusion optimization engine 132 identifies or generates fused kernel configurations that maintain security levels (and thus privacy boundaries).

In an example, the privacy-aware kernel fusion optimization applies the following function: F(k)=argmax(P(k)) where: P(k) is a privacy-performance score, and k ∈{possible_fusion_patterns}. Relevant optimization constraints for the privacy-aware kernel fusion process may include but are not limited to privacy boundary preservation, maximum latency requirements, resource availability, and accuracy maintenance.

The data protection boundary management subsystem 140 is configured to control transitions of protected data and computation operations occurring between different privacy domains, while establishing secure protocols for data transfer, monitoring security metrics, and optimizing overall operations. The associated data protection operations may be optimized for minimal encryption/decryption operations, secure boundary crossing, and resource efficiency.

The data protection boundary management subsystem 140 includes a privacy domain security engine 141 to implement a gateway protocol. This may include implementing secure handshaking between privacy domains, performing validation checks before domain transitions, managing encryption key exchange and verification, and handling protocol buffers for efficient data serialization. The privacy domain security engine 141 may implement a domain transition protocol that applies the following function: T(d₁, d₂)={validation: security_checks, encryption: level_adjustment, verification: integrity_proof, performance: overhead_monitoring}.

The privacy domain security engine 141 can also segment portions of the neural network into regions based on data sensitivity. This may be tracked in a directed graph where each node is an operation and each edge shows data flow (e.g., coloring each node according to its security domain). For instance, a face recognition network might have feature extraction functions associated with domain 3 (associated with a lower security level) but have identity matching functions associated in domain 1 (associated with a highest security level).

The data protection boundary management subsystem 140 also includes a security monitor 142 to perform various security monitoring functions among communicated and stored data. These functions may include privacy guarantee verification, performance impact tracking, resource utilization monitoring, and violation detection and mitigation.

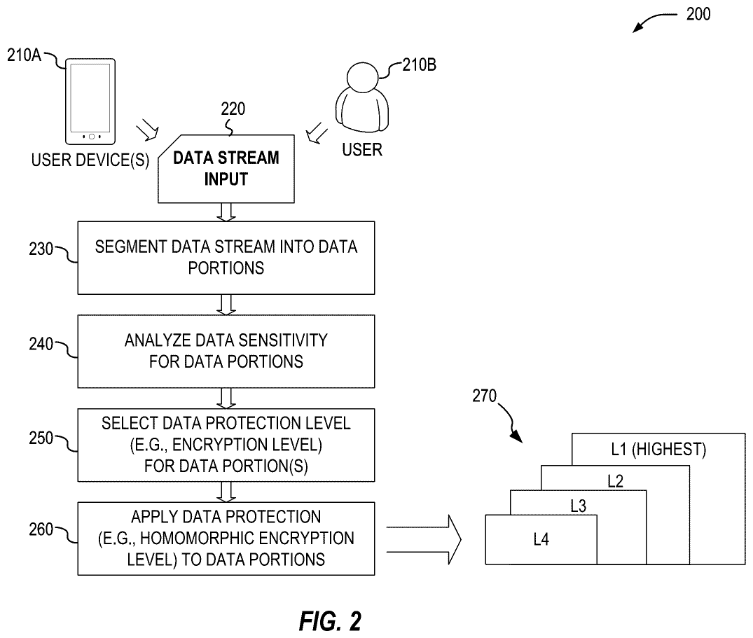

FIG. 2 illustrates a schematic data flow in an example data protection system (e.g., an implementation of data protection system 110) that is configured to perform privacy-preserving data processing. Consider a scenario where a user device 210A and/or a user 210B produces a data stream input 220 that includes a mix of different sensitivity levels (such as non-sensitive data and sensitive data provided from personally identifying information (PII), personal health information (PHI), biometric data, sensor data, etc.).

In some examples, sensitivity score metadata is applied directly to data tensors at input time. For instance, in a healthcare application, personal identifiers receive a 0.9 tag, vital signs a 0.6 tag, and anonymized statistics a 0.2 tag. These tags can propagate with the data through the computational pipeline to ensure that a respective data portion can be assessed for the correct security level.

The data protection system may analyze the data stream input 220 as follows. First, at operation 230, the data protection system segments or partitions the data stream into data portions. The segments or portions of data may be identified based on time characteristics (e.g., separate video frames), spatial characteristics (e.g., sections of an image), data size or discrete data values, or a variety of other properties. Next, at operation 240, the data protection system analyzes the data sensitivity of the various data portions. Analyzing data sensitivity may include using the sensitivity scoring functions of the data sensitivity analysis engine 121, described above, or a similar approach.

Next, at operation 250, the data protection system selects a level of security for data protection (e.g., an encryption level) for the various data portions. The particular security level can be based on a sensitivity score assigned to each respective data portion, including using the security levels of the multi-level encryption manager 122, described above, or a similar approach.

Next, at operation 260, the data protection system applies data protection (e.g., applying a specific homomorphic encryption level corresponding to a particular security level) to the various data portions. This produces various groups of protected (e.g., encrypted) data at different levels such as encrypted data portions 270 shown with a first set of encrypted data L1 at a highest security level, a second set of encrypted data L2 at a lower security level, a third set of encrypted data L3 at an even lower security level, and a fourth set of encrypted data L4 at the lowest security level.

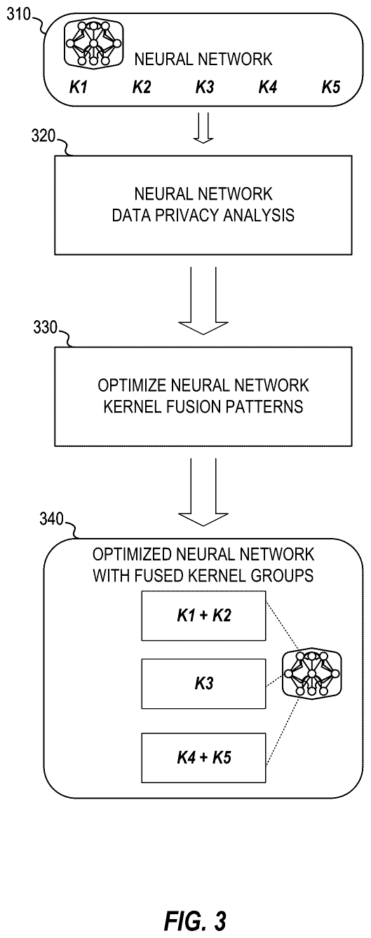

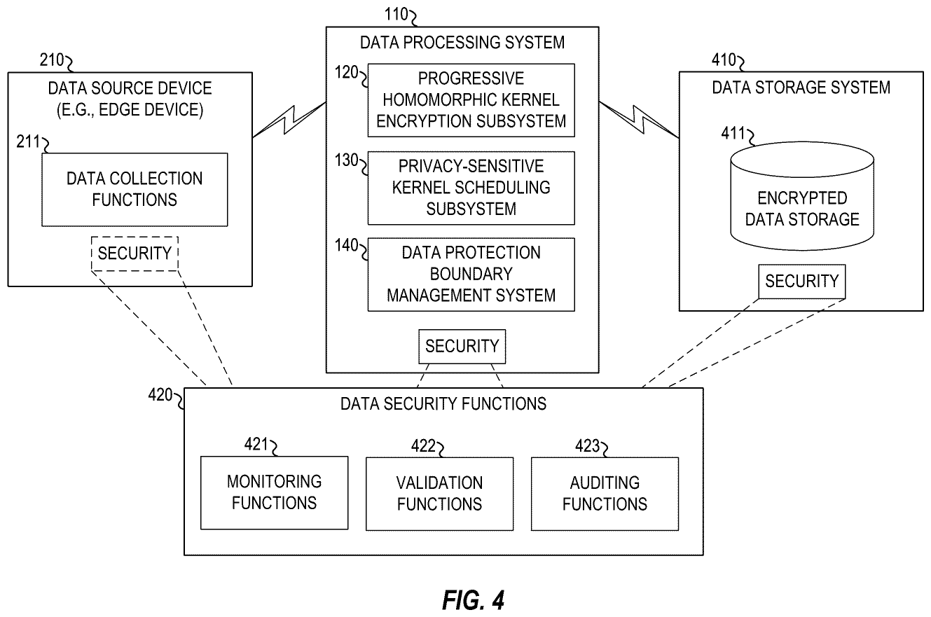

Further operations coordinated with the data input processing of FIG. 2 may include optimizing kernel fusion patterns (depicted in more detail in FIG. 3) and managing privacy boundaries and monitoring security metrics (described in more detail in FIG. 4). Additionally, technical enhancements to operations performed with the data input processing of FIG. 2 may include: caching of encryption parameters for frequently used operations; parallel processing of independent privacy domains; optimized memory management for encrypted operations; and the application of hardware acceleration where available.

FIG. 3 illustrates a schematic data flow of optimizing neural network kernel fusion patterns based on data privacy analysis. As shown, a neural network 310 can be segmented or divided into multiple kernels that perform computation operations. For instance, a kernel may encompass the matrix used in a convolutional neural network that applies convolution operations. An individual kernel may be designed to detect specific features in the input data, and so different kernels can be used to detect different types of features.

At operation 320, the structure of the neural network is analyzed, to perform a data privacy analysis on the structure of the neural network and its various kernels. This may include producing a kernel computational graph, a type of data structure that represents the relationships among the kernels of the neural network. For instance, the kernel computational graph may be used to identify and optimize grouping and scheduling (and overall performance) of computations performed by the neural network.

At operation 330, the neural network kernel fusion patterns are optimized. This optimization may be performed by analyzing the kernel graph and privacy constraints as inputs and identifying optimized patterns to combine the kernels. These optimized patterns can be applied while respecting any privacy requirements for handling data at the particular kernel. For instance, adjacent operations in the kernel computational graph can be placed or relocated to identify groups of operations that could be merged for better performance. For each potential merge, a verification is performed to ensure that all operations share the same security domain, and fusion opportunities are rejected if they would cross security boundaries. As an example, if operations A→B→C are in domain 2, but operation D (which follows C) is in domain 1, a fusion will be performed on A+B+C but D will be kept separate.

This data flow produces an optimized neural network 340, with fused kernel groups. A fused kernel, in this context, is a combined component of a model (e.g., a neural network) that performs related data processing operations such as matrix multiplication or activation functions in a single step, instead of in multiple steps, and can enable the model to work faster. For example, in a scenario where kernels K1 and K2 perform operations on data of the same sensitivity level (e.g., not sensitive data), then kernels K1 and K2 can be fused; where kernel K3 is the only kernel that performs operations on data of a moderate sensitivity level, this kernel is not fused; where kernels K4 and K5 perform operations on data of the same sensitivity level (e.g., sensitive data with some higher level of encryption), then kernels K4 and K5 can be fused.

Thus, the system generates optimized fused kernels for operations within the same security domain, using specialized compilers for each encryption scheme. As a non-limiting example, the following domains can be defined to produce kernels with the following attributes:
Domain 1 (highest security): Operates directly on TFHE ciphertexts
Domain 2: Uses BGV-specific operations with polynomial restrictions
Domain 3: Implements Paillier-compatible operations (addition, scalar multiplication)
Domain 4: Uses conventional optimization with minimal security overhead

A compiler can apply domain-specific optimizations such as ciphertext packing in Domain 1 or multi-precision arithmetic in Domain 2 as applicable.

FIG. 4 illustrates a schematic block diagram of an architecture for distributed data processing and security functions. Here, this shows the relationship among distributed functions performed at a data source device 210 (such as an edge device discussed above), the data protection system 110, and a data storage system 410. Each of these entities performs one or more data security functions 420. In some examples, workloads with different security requirements can be separated for execution on different corresponding platforms.

The data security functions 420 include monitoring functions 421, validation functions 422, and auditing functions 423. In particular, the monitoring functions 421 may be used to detect the transition of data between different security domains. For instance, data collection functions 211 may be used to apply security protections directly on-device and before communicating the data to the data protection system 110. The data storage system 410 may apply the security functions for storage and retrieval of data in a protected data store such as encrypted data storage 411.

The validation functions 422 can be used to check if the transition of some data between a source domain and a target domain is allowed, in connection with data protection requirements and boundaries. In some examples, if the transition is allowed, the security level (e.g., encryption level) of the data is changed to match the requirements of the new domain. The auditing functions 423 can be used to record the transition in a security log. If the transition is not approved, a security error may be logged.

Each of the devices 210 and systems 110, 410 may include hardware-assisted mechanisms to assist with security. For instance, each system may include memory protection features to enforce domain separation. Domain 1 data might use encrypted memory pages with restricted access, whereas Domain 2 might use integrity-protected memory. Memory allocations can include security domain metadata. A hardware memory management unit (MMU) can be configured to enforce these protections to prevent accidental cross-domain access.

In further examples, cross-domain data movement is performed using a combination of boundary transition detection, policy enforcement, and encryption transformation. To enable boundary transition detection, the system identifies points in the computational graph where data must flow between security domains. For example, this may be encountered in an example where person detection results (Domain 3) need to be combined with face recognition results (Domain 1). For each point of this type, a “gateway node” can be created in the computational graph. Each gateway node contains a policy check function. This policy check function examines the actual data and intended transition, and the function may consult a policy database to determine if the transition is allowed. The policies may include rules such as, “face embeddings cannot move to domain 3 or lower”. If a policy forbids the transition, then the execution fails with a security exception.

Various forms of encryption transformation may be implemented. For instance, for moving to higher security (e.g., Domain 3 to Domain 1), the system allocates memory in the higher security domain, copies the source data values, applies the stronger encryption scheme to these values, verifies the encryption completed successfully, and zeroes and releases the original memory. For moving to lower security (e.g., Domain 1 to Domain 3), the system applies data filtering first to remove sensitive components, performs partial decryption of allowed fields only, verifies no sensitive data remains, applies the lighter encryption scheme, and records this downgrade in a tamper-proof audit log.

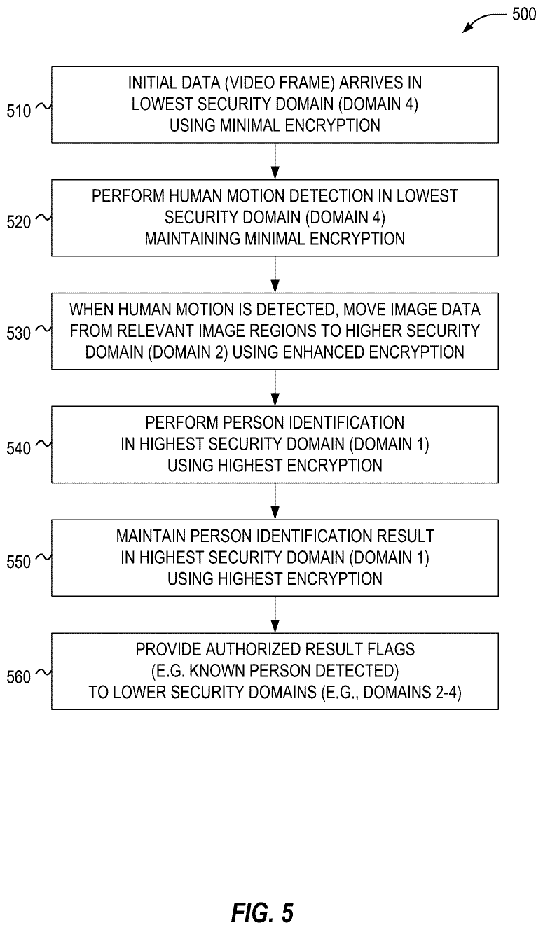

FIG. 5 illustrates a flowchart 500 of a use case for processing video data including data transfer operations among multiple security domains. Here, this flowchart 500 provides an example walkthrough of a real-world use case, involving a smart home security system processing video. Similar adaptation of these operations may be provided for other types of video and data processing.

At operation 510, an initial video frame arrives in Domain 4 (e.g., a lowest security level), such as with a real-time sensor data stream. At operation 520, general motion detection happens in Domain 4 with minimal encryption of the data.

At operation 530, when human motion is detected in the image data, relevant image regions move to Domain 2 (e.g., a higher encryption level, with an enhanced encryption level but not the highest encryption level). The operations in this region may be coordinated to detect objects or actions and to trigger person identification processing.

At operation 540, person identification processing is performed on the image data in Domain 1 (e.g., a highest encryption level). At operation 550, the person identification result (e.g., identifying the particular identity of a person, and any associated image data) is maintained in Domain 1 (e.g., the highest encryption level).

At operation 560, information such as authorized result flags (e.g., a “known person detected”) can move back to lower security domains (e.g., Domains 2-4 that use a lower encryption level). However, the detailed identity information of the detected remains in Domain 1 (e.g., which uses the highest encryption level). As discussed above, monitoring and validation may be used to ensure that data transferred with each domain transition will experience explicit gateway checks.

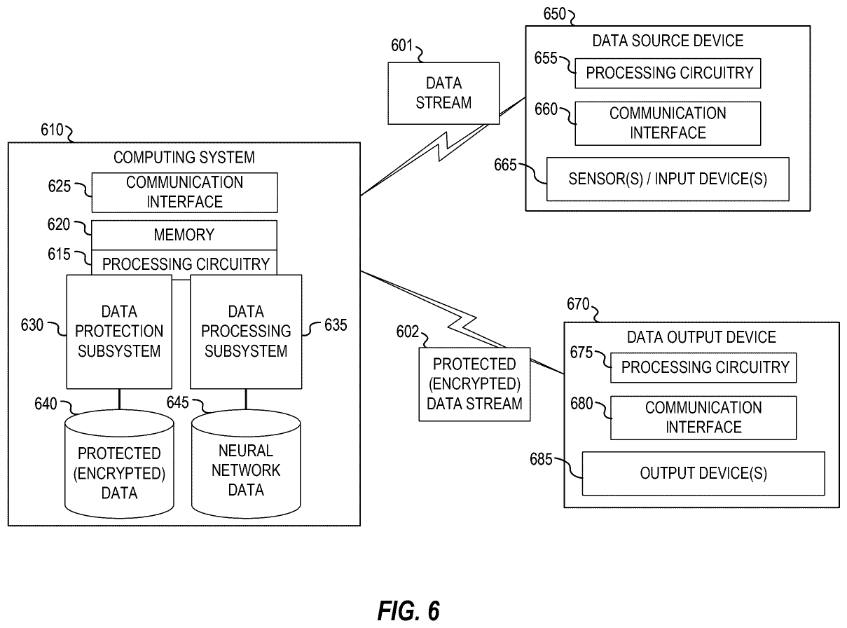

FIG. 6 illustrates a schematic of operational and functional components provided among distributed computing systems and devices to implement the present data protection techniques. These components include a computing system 610, a data source device 650, a data output device 670, and various sub-components that are included or associated with the data protection operations discussed herein. The components shown in FIG. 6 may be embodied or implemented in hardware, software, or any combination thereof. The functionality of each component is one example arrangement of functionality and one of ordinary skill with the benefit of the present disclosure will appreciate that other organizations are possible.

Each of the illustrated systems 610 and devices 650, 670 are depicted as including processing circuitry 615, 655, 675, such as a CPU configured to execute respective software instructions provided by memory 620 or on a storage medium (e.g., hosting or storing the instructions). First, the computing system 610 is depicted as including a data protection subsystem 630 and a data processing subsystem 635. For instance, the computing system may apply data protection, using the data protection subsystem 630, to a data stream 601 received from a data source device 650. Once data protection is applied, a protected data stream 602 (e.g., encrypted data stream) may be communicated to a data output device 670.

The computing system 610 may operate the data protection subsystem 630 to apply different levels (e.g., different strengths) of data protection to the received such as encryption, transformation, masking, obfuscation, or tokenization, corresponding to the sensitivity of the received data. The computing system may operate the data processing subsystem 635 to perform computations on the received data, such with the execution of a neural network, machine learning, or artificial intelligence model. The model may be provided from neural network data 645 such as a data store that includes neural network model binaries, kernels, weights, and related data representations. The computing system 610 may use the data protection subsystem 630 and the data processing subsystem 635 to perform privacy-sensitive operations for a variety of data processing use cases, such as video processing described above for FIG. 5, or for other input/output use scenarios. The computing system 610 may maintain a version of the protected data 640 (e.g., with encryption) in a database or other data store.

The data source device 650 may constitute a wearable or peripheral device that collects data from one or more integrated or external sensors or input devices 665. The data source device 650 can communicate the data stream 601 via a communication interface 660 to the communication interface 625 of the computing system 610. The data output device 670 may constitute a peripheral or connected device that provides some output or transformation of protected data or derived information of the protected data stream 602 on an output device 685. This protected data stream 602 can be received at the data output device 670 via a communication interface 680 operably connected to the communication interface 625 of the computing system 610. For simplicity, specific types and configurations of input devices and output devices are not illustrated, but such architecture may encompass many types of low-power and low-resource edge devices.

The communication interfaces may include software and/or hardware components to facilitate the data transfer, and to associate, authenticate, and connect to various networks, including with the use of network stacks (such as Transmission Control Protocol (TCP), Internet Protocol, one or more protocol layers specified by an 802.11 family of standards promulgated by the Institute for Electrical and Electronics Engineers (IEEE), and the like). The computing devices may also include other network interfaces for communicating via various types of wired or wireless networks.

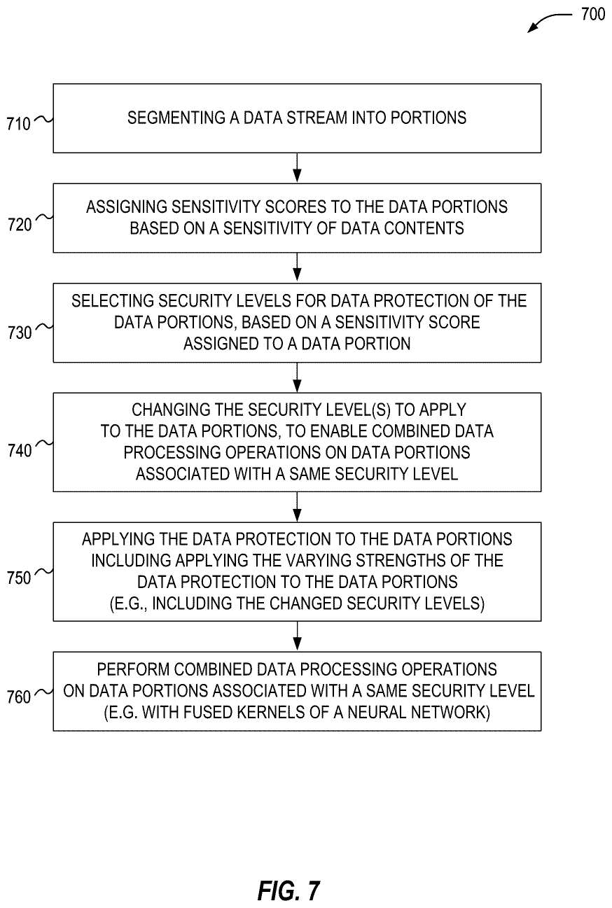

FIG. 7 depicts a flowchart 700 of a method for optimizing data protection for a data stream, including through implementation of the detailed algorithms and techniques discussed above for the processing of a sensor data stream. The operations of the flowchart 700, however, are not limited to sensor data processing or the use of AI models, as the operations for sensitivity scoring and combined data processing can be used in other contexts.

The flowchart 700 of FIG. 7 commences with an operation to segment a data stream into portions (operation 710), such as identifying data portions from individual frames of a video stream, images from a camera, intervals from a sensor device, etc. In a specific example, the data stream comprises sensor data to be processed (e.g., classified) by a trained artificial intelligence (AI) model (e.g., a trained neural network). With the following operations, varying strengths of data protection can be applied to the sensor data based on attributes of personally identifiable information or other private characteristics that are included in the sensor data.

The flowchart 700 continues with operations to assign sensitivity scores to the data portions based on a sensitivity of the data contents (operation 720), to enable a respective sensitivity score to be assigned to a respective data portion. Consistent with the examples above, the sensitivity scores can be determined using a trained machine learning model, and such sensitivity scores can be tracked with sensitivity metadata associated with the respective data portion.

The flowchart 700 continues with operations to select security levels for data protection of the data portions, based on a sensitivity score assigned to a data portion (operation 730). In an example where the data protection includes encryption, such security levels can be selected from among: a first encryption level for highest sensitivity data, corresponding to full homomorphic encryption; a second encryption level for moderate sensitivity data, corresponding to a partial homomorphic encryption; and a third encryption level for low sensitivity data, corresponding to an encryption technique without use of homomorphic encryption.

The flowchart 700 continues with operations to change the security level(s) to apply to the data portions (operation 740), to enable combined data processing operations on data portions associated with a same security level. For instance, in an example where data processing operations include the use of fused kernels, changing the security levels can include increasing or decreasing a security level of a respective data portion based on data flows to be performed among the fused kernels that are associated with different security levels. Such changes can be made while evaluating and maintaining privacy boundaries for the data flows to be performed among the fused kernels.

The flowchart 700 continues with operations to apply the data protection to the data portions (operation 750), such as by applying the varying strengths of the data protection (e.g., varying strengths of encryption) to the data portions (e.g., including the changed security levels).

The flowchart 700 concludes with optional operations to perform combined data processing operations on data portions associated with a same security level, such as with fused kernels of a neural network (operation 760). In other examples, the combined data processing operations may be performed by another entity. For instance, the combined data processing operations can be performed with fused kernels of a neural network, such as in a scenario where a respective kernel of the fused kernels performs the combined data processing operations on the data portions associated with a same security level.

In further examples, specific techniques may be used to determine the sensitivity scores assigned to various data portions. For example, the sensitivity scores cab be determined based on an evaluation function that evaluates a criticality of the data contents of the respective data portion and at least one regulatory requirement applicable to the data contents of the respective data portion. In such a context, criticality defines a harm of exposure and the at least one regulatory requirement defines rules to prevent the exposure. This evaluation function can apply a first weight corresponding to the criticality and a second weight corresponding to the at least one regulatory requirement. The sensitivity scores can be further determined based on an amount of information of the data contents of the respective data portion, and the evaluation function can apply a third weight corresponding to the amount of information.

In still further examples, techniques may be performed before or during the operations of flowchart 700 to optimize kernel fusion operations for a neural network used in the combined data processing operations. This may include dividing the neural network into respective network regions corresponding to the security levels, based on a sensitivity of operations performed in the respective network regions, and performing kernel fusion operations that generate the fused kernels based on network regions associated with the same security level. Such fusion operations may be arranged ahead of time based on a sensitivity of inferencing, prediction, or data handling operations that occur or are possible to occur in the neural network.

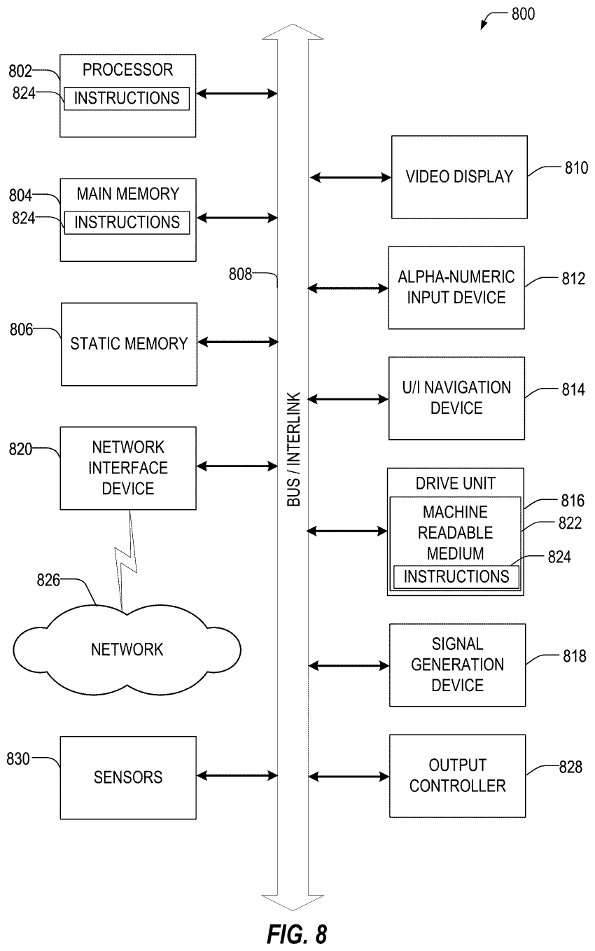

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a computing device such as a personal computer (PC), a tablet PC, a personal digital assistant (PDA), a mobile telephone, a cloud-based or networked server, a virtualized server, a smart phone, a web appliance, a network router, an access point, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 800 specifically may implement the devices 210, 650, 670, and systems 110, 410, and 610, or the operations illustrated among the methods implemented in FIGS. 1-7.

Examples, as described herein, may include, or may operate on, logic or a number of components, modules, or mechanisms (hereinafter “components”). Such components are tangible entities (e.g., hardware) capable of performing specified operations and may be configured or arranged in a certain manner. In an example, circuits or circuitry may be arranged (e.g., internally or with respect to external entities such as other circuits or circuitry) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium, such as a non-transitory machine-readable storage medium. In an example, the software, when executed by the underlying hardware of the component, causes the hardware to perform the specified operations.

Accordingly, such a component encompasses a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. Examples of main memory 404 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 830, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, a machine-readable medium may include a single medium or multiple media (e.g., a centralized or distributed database, and/or associated caches and servers) configured to store the one or more instructions 824. Thus, the term machine readable medium may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions.

Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media (e.g., excluding a transitory propagating signal).

The instructions 824 may further be transmitted or received over a communications network 826 using a transmission medium via the network interface device 820. The machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), satellite communication networks, and wireless data networks, such as networks implementing the Institute of Electrical and Electronics Engineers (IEEE) 802.11 family of standards known as Wi-Fi®, a 5G or 4G/Long Term Evolution (LTE) family of standards, satellite communication networks, peer-to-peer (P2P) networks, among others. In an example, the network interface device 820 may include one or more physical interfaces (e.g., Ethernet, coaxial, or optical interfaces) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a computer-implemented method for optimizing data protection for a data stream, comprising: segmenting the data stream into data portions; assigning sensitivity scores to the data portions based on a sensitivity of data contents, wherein a respective sensitivity score is assigned to a respective data portion; selecting security levels for data protection of the data portions based on a respective sensitivity score assigned to a respective data portion, wherein the security levels correspond to varying strengths of the data protection; changing one or more of the security levels to apply to the data portions, wherein the data portions are processed with combined data processing operations on the data portions associated with a same security level; and applying the data protection to the data portions by applying the varying strengths of the data protection to the data portions in accordance with the changed security levels.

In Example 2, the subject matter of Example 1 optionally includes wherein the combined data processing operations are performed with fused kernels of a neural network, and wherein a respective kernel of the fused kernels performs the combined data processing operations on the data portions associated with a same security level.

In Example 3, the subject matter of Example 2 optionally includes wherein changing the security levels includes increasing or decreasing a security level of a respective data portion based on data flows to be performed among the fused kernels that are associated with different security levels, while maintaining privacy boundaries for the data flows to be performed among the fused kernels.

In Example 4, the subject matter of any one or more of Examples 2-3 optionally include dividing the neural network into respective network regions corresponding to the security levels, based on a sensitivity of operations performed in the respective network regions; and performing kernel fusion operations that generate the fused kernels based on network regions associated with the same security level.

In Example 5, the subject matter of Example 4 optionally includes wherein the kernel fusion operations are optimized based on a kernel graph and security constraints of data processing corresponding to the security levels.

In Example 6, the subject matter of any one or more of Examples 1-5 optionally include wherein the data protection comprises encryption, and wherein the security levels are selected from among: a first encryption level for highest sensitivity data, corresponding to full homomorphic encryption; a second encryption level for moderate sensitivity data, corresponding to a partial homomorphic encryption; and a third encryption level for low sensitivity data, corresponding to an encryption technique without use of homomorphic encryption.

In Example 7, the subject matter of any one or more of Examples 1-6 optionally include wherein the sensitivity scores are determined using a trained machine learning model, and wherein the sensitivity scores are tracked with sensitivity metadata associated with the respective data portion.

In Example 8, the subject matter of Example 7 optionally includes wherein the sensitivity scores are determined based on a function that evaluates a criticality of the data contents of the respective data portion and at least one regulatory requirement applicable to the data contents of the respective data portion, wherein the criticality defines a harm of exposure and wherein the at least one regulatory requirement defines rules to prevent the exposure, and wherein the function applies a first weight corresponding to the criticality and a second weight corresponding to the at least one regulatory requirement.

In Example 9, the subject matter of Example 8 optionally includes wherein the sensitivity scores are further determined based on an amount of information of the data contents of the respective data portion, and wherein the function applies a third weight corresponding to the amount of information.

In Example 10, the subject matter of any one or more of Examples 1-9 optionally include wherein the data stream comprises sensor data to be processed by a trained artificial intelligence (AI) model, and wherein the varying strengths of the data protection are applied to the sensor data based on attributes of personally identifiable information that are included in the sensor data.

Example 11 is a non-transitory machine-readable medium, storing instructions for optimizing data protection for a data stream, the instructions, which when executed, cause a machine to perform operations comprising: segmenting the data stream into data portions; assigning sensitivity scores to the data portions based on a sensitivity of data contents, wherein a respective sensitivity score is assigned to a respective data portion; selecting security levels for data protection of the data portions based on a respective sensitivity score assigned to a respective data portion, wherein the security levels correspond to varying strengths of the data protection; changing one or more of the security levels to apply to the data portions, wherein the data portions are processed with combined data processing operations on the data portions associated with a same security level; and applying the data protection to the data portions by applying the varying strengths of the data protection to the data portions in accordance with the changed security levels.

In Example 12, the subject matter of Example 11 optionally includes wherein the combined data processing operations are performed with fused kernels of a neural network, and wherein a respective kernel of the fused kernels performs the combined data processing operations on the data portions associated with a same security level.

In Example 13, the subject matter of Example 12 optionally includes wherein determining the security levels includes increasing or decreasing a security level of a respective data portion based on data flows to be performed among the fused kernels that are associated with different security levels, while maintaining privacy boundaries for the data flows to be performed among the fused kernels.

In Example 14, the subject matter of any one or more of Examples 12-13 optionally include the operations further comprising: dividing the neural network into respective network regions corresponding to the security levels, based on a sensitivity of operations performed in the respective network regions; and performing kernel fusion operations that generate the fused kernels based on network regions associated with the same security level.

In Example 15, the subject matter of Example 14 optionally includes wherein the kernel fusion operations are optimized based on a kernel graph and security constraints of data processing corresponding to the security levels.

In Example 16, the subject matter of any one or more of Examples 11-15 optionally include wherein the data protection comprises encryption, and wherein the security levels are selected from among: a first encryption level for highest sensitivity data, corresponding to full homomorphic encryption; a second encryption level for moderate sensitivity data, corresponding to a partial homomorphic encryption; and a third encryption level for low sensitivity data, corresponding to an encryption technique without use of homomorphic encryption.

In Example 17, the subject matter of any one or more of Examples 11-16 optionally include wherein the sensitivity scores are determined using a trained machine learning model, and wherein the sensitivity scores are tracked with sensitivity metadata associated with the respective data portion.

In Example 18, the subject matter of Example 17 optionally includes wherein the sensitivity scores are determined based on a function that evaluates a criticality of the data contents of the respective data portion and at least one regulatory requirement applicable to the data contents of the respective data portion, wherein the criticality defines a harm of exposure and wherein the at least one regulatory requirement defines rules to prevent the exposure, and wherein the function applies a first weight corresponding to the criticality and a second weight corresponding to the at least one regulatory requirement.

In Example 19, the subject matter of Example 18 optionally includes wherein the sensitivity scores are further determined based on an amount of information of the data contents of the respective data portion, and wherein the function applies a third weight corresponding to the amount of information.

In Example 20, the subject matter of any one or more of Examples 11-19 optionally include wherein the data stream comprises sensor data to be processed by a trained artificial intelligence (AI) model, and wherein the varying strengths of the data protection are applied to the sensor data based on attributes of personally identifiable information that are included in the sensor data.

Example 21 is a computing device for optimizing data protection for a data stream, the computing device comprising: a hardware processor; an interface to receive the data stream; and a memory, the memory storing instructions, which when executed by the hardware processor, cause the computing device to perform operations that: segment the data stream into data portions; assign sensitivity scores to the data portions based on a sensitivity of data contents, wherein a respective sensitivity score is assigned to a respective data portion; select security levels for data protection of the data portions based on a respective sensitivity score assigned to a respective data portion, wherein the security levels correspond to varying strengths of the data protection; change one or more of the security levels to apply to the data portions, wherein the data portions are processed with combined data processing operations on the data portions associated with a same security level; and apply the data protection to the data portions by applying the varying strengths of the data protection to the data portions in accordance with the changed security levels.

In Example 22, the subject matter of Example 21 optionally includes wherein the combined data processing operations are performed with fused kernels of a neural network, and wherein a respective kernel of the fused kernels performs the combined data processing operations on the data portions associated with a same security level.

In Example 23, the subject matter of Example 22 optionally includes wherein to determine the security levels includes to increase or decrease a security level of a respective data portion based on data flows to be performed among the fused kernels that are associated with different security levels, while maintaining privacy boundaries for the data flows to be performed among the fused kernels.

In Example 24, the subject matter of any one or more of Examples 22-24 optionally include wherein the instructions further cause the computing device to perform operations that: separate the neural network into respective network regions corresponding to the security levels, based on a sensitivity of operations performed in the respective network regions; and perform kernel fusion operations that generate the fused kernels based on network regions associated with the same security level.

In Example 25, the subject matter of Example 24 optionally includes wherein the kernel fusion operations are optimized based on a kernel graph and security constraints of data processing corresponding to the security levels.

In Example 26, the subject matter of any one or more of Examples 21-25 optionally include wherein the data protection comprises encryption, and wherein the security levels are selected from among: a first encryption level for highest sensitivity data, corresponding to full homomorphic encryption; a second encryption level for moderate sensitivity data, corresponding to a partial homomorphic encryption; and a third encryption level for low sensitivity data, corresponding to an encryption technique without use of homomorphic encryption.

In Example 27, the subject matter of any one or more of Examples 21-26 optionally include wherein the sensitivity scores are determined using a trained machine learning model, and wherein the sensitivity scores are tracked with sensitivity metadata associated with the respective data portion.

In Example 28, the subject matter of Example 27 optionally includes wherein the sensitivity scores are determined based on a function that evaluates a criticality of the data contents of the respective data portion and at least one regulatory requirement applicable to the data contents of the respective data portion, wherein the criticality defines a harm of exposure and wherein the at least one regulatory requirement defines rules to prevent the exposure, and wherein the function applies a first weight corresponding to the criticality and a second weight corresponding to the at least one regulatory requirement.

In Example 29, the subject matter of Example 28 optionally includes wherein the sensitivity scores are further determined based on an amount of information of the data contents of the respective data portion, and wherein the function applies a third weight corresponding to the amount of information.

In Example 30, the subject matter of any one or more of Examples 21-29 optionally include wherein the data stream comprises sensor data to be processed by a trained artificial intelligence (AI) model, and wherein the varying strengths of the data protection are applied to the sensor data based on attributes of personally identifiable information that are included in the sensor data.

Example 31 is at least one machine-readable medium (e.g., a non-transitory computer-readable storage medium) including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

What is claimed is:

1. A method for optimizing data protection for a data stream, comprising:
segmenting the data stream into data portions;
assigning sensitivity scores to the data portions based on a sensitivity of data contents, wherein a respective sensitivity score is assigned to a respective data portion;
selecting security levels for data protection of the data portions based on a respective sensitivity score assigned to a respective data portion, wherein the security levels correspond to varying strengths of the data protection;
changing one or more of the security levels to apply to the data portions, wherein the data portions are processed with combined data processing operations on the data portions associated with a same security level; and
applying the data protection to the data portions by applying the varying strengths of the data protection to the data portions in accordance with the changed security levels.

2. The method of claim 1, wherein the combined data processing operations are performed with fused kernels of a neural network, and wherein a respective kernel of the fused kernels performs the combined data processing operations on the data portions associated with a same security level.

3. The method of claim 2, wherein changing the security levels includes increasing or decreasing a security level of a respective data portion based on data flows to be performed among the fused kernels that are associated with different security levels, while maintaining privacy boundaries for the data flows to be performed among the fused kernels.

4. The method of claim 2, further comprising:
dividing the neural network into respective network regions corresponding to the security levels, based on a sensitivity of operations performed in the respective network regions; and
performing kernel fusion operations that generate the fused kernels based on network regions associated with the same security level.

5. The method of claim 4, wherein the kernel fusion operations are optimized based on a kernel graph and security constraints of data processing corresponding to the security levels.

6. The method of claim 1, wherein the data protection comprises encryption, and wherein the security levels are selected from among:
a first encryption level for highest sensitivity data, corresponding to full homomorphic encryption;
a second encryption level for moderate sensitivity data, corresponding to a partial homomorphic encryption; and
a third encryption level for low sensitivity data, corresponding to an encryption technique without use of homomorphic encryption.

7. The method of claim 1, wherein the sensitivity scores are determined using a trained machine learning model, and wherein the sensitivity scores are tracked with sensitivity metadata associated with the respective data portion.

8. The method of claim 7, wherein the sensitivity scores are determined based on a function that evaluates a criticality of the data contents of the respective data portion and at least one regulatory requirement applicable to the data contents of the respective data portion,
wherein the criticality defines a harm of exposure and wherein the at least one regulatory requirement defines rules to prevent the exposure, and
wherein the function applies a first weight corresponding to the criticality and a second weight corresponding to the at least one regulatory requirement.

9. The method of claim 8, wherein the sensitivity scores are further determined based on an amount of information of the data contents of the respective data portion, and wherein the function applies a third weight corresponding to the amount of information.

10. The method of claim 1, wherein the data stream comprises sensor data to be processed by a trained artificial intelligence (AI) model, and wherein the varying strengths of the data protection are applied to the sensor data based on attributes of personally identifiable information that are included in the sensor data.

11. A non-transitory machine-readable medium, storing instructions for optimizing data protection for a data stream, the instructions, which when executed, cause a machine to perform operations comprising:
segmenting the data stream into data portions;
assigning sensitivity scores to the data portions based on a sensitivity of data contents, wherein a respective sensitivity score is assigned to a respective data portion;
selecting security levels for data protection of the data portions based on a respective sensitivity score assigned to a respective data portion, wherein the security levels correspond to varying strengths of the data protection;
changing one or more of the security levels to apply to the data portions, wherein the data portions are processed with combined data processing operations on the data portions associated with a same security level; and
applying the data protection to the data portions by applying the varying strengths of the data protection to the data portions in accordance with the changed security levels.

12. The non-transitory machine-readable medium of claim 11, wherein the combined data processing operations are performed with fused kernels of a neural network, and wherein a respective kernel of the fused kernels performs the combined data processing operations on the data portions associated with a same security level.

13. The non-transitory machine-readable medium of claim 12, wherein determining the security levels includes increasing or decreasing a security level of a respective data portion based on data flows to be performed among the fused kernels that are associated with different security levels, while maintaining privacy boundaries for the data flows to be performed among the fused kernels.

14. The non-transitory machine-readable medium of claim 12, the operations further comprising:
dividing the neural network into respective network regions corresponding to the security levels, based on a sensitivity of operations performed in the respective network regions; and
performing kernel fusion operations that generate the fused kernels based on network regions associated with the same security level, wherein the kernel fusion operations are optimized based on a kernel graph and security constraints of data processing corresponding to the security levels.

15. The non-transitory machine-readable medium of claim 11, wherein the data protection comprises encryption, and wherein the security levels are selected from among:
a first encryption level for highest sensitivity data, corresponding to full homomorphic encryption;
a second encryption level for moderate sensitivity data, corresponding to a partial homomorphic encryption; and
a third encryption level for low sensitivity data, corresponding to an encryption technique without use of homomorphic encryption.

16. A computing device for optimizing data protection for a data stream, the computing device comprising:
a hardware processor;
an interface to receive the data stream; and
a memory, the memory storing instructions, which when executed by the hardware processor, cause the computing device to perform operations that:
segment the data stream into data portions;
assign sensitivity scores to the data portions based on a sensitivity of data contents, wherein a respective sensitivity score is assigned to a respective data portion;
select security levels for data protection of the data portions based on a respective sensitivity score assigned to a respective data portion, wherein the security levels correspond to varying strengths of the data protection;
change one or more of the security levels to apply to the data portions, wherein the data portions are processed with combined data processing operations on the data portions associated with a same security level; and
apply the data protection to the data portions by applying the varying strengths of the data protection to the data portions in accordance with the changed security levels.

17. The computing device of claim 16, wherein the combined data processing operations are performed with fused kernels of a neural network, and wherein a respective kernel of the fused kernels performs the combined data processing operations on the data portions associated with a same security level.

18. The computing device of claim 17, wherein to determine the security levels includes to increase or decrease a security level of a respective data portion based on data flows to be performed among the fused kernels that are associated with different security levels, while maintaining privacy boundaries for the data flows to be performed among the fused kernels.

19. The computing device of claim 17, wherein the instructions further cause the computing device to perform operations that:
separate the neural network into respective network regions corresponding to the security levels, based on a sensitivity of operations performed in the respective network regions; and
perform kernel fusion operations that generate the fused kernels based on network regions associated with the same security level, wherein the kernel fusion operations are optimized based on a kernel graph and security constraints of data processing corresponding to the security levels.

20. The computing device of claim 16, wherein the data protection comprises encryption, and wherein the security levels are selected from among:
a first encryption level for highest sensitivity data, corresponding to full homomorphic encryption;
a second encryption level for moderate sensitivity data, corresponding to a partial homomorphic encryption; and
a third encryption level for low sensitivity data, corresponding to an encryption technique without use of homomorphic encryption.
